(19) United States
(12) Patent Application Publication
(10) Pub. No.: US 2009/0313497 A1
(43) Pub. Date: Dec. 17, 2009

(54) Failover Enabled Telemetry Systems

(75) Inventors: Uzi Lumbroso, Ra'anana (IL); Andrey Nekhamkin, Petach Tikva (IL)

Correspondence Address: MYERS WOLIN, LLC, 100 HEADQUARTERS PLAZA, North Tower, 6th Floor, MORRISTOWN, NJ, 07960-6834, US

(73) Assignee: LAROTEC LTD., Petach Tikva (IL)

(21) Appl. No.: 12/536,208

(22) Filed: Aug. 5, 2009

Related U.S. Application Data
(63) Continuation of application No. PCT/US2008/053361, filed on Feb. 7, 2008.
(60) Provisional application No. 60/888,759, filed on Feb. 7, 2007.

(51) Int. Cl. G06F 11/07

(52) U.S. Cl. 714/3; 714/57; 714/2; 714/E11.023; 714/E11.025

(57) ABSTRACT

The present invention discloses several techniques for providing failover in telemetry systems. The invention allows the continuous and uninterrupted connection between gathering units and a central data collection server, thereby ensuring the proper operation of telemetry systems.

### CROSS REFERENCE TO RELATED APPLICATIONS

This Application is a continuation of PCT Patent Application No. PCT/US08/053361 having International filing date of Feb. 7, 2008, which claims the benefit of U.S. Provisional Application No. 60/888,759 filed on Feb. 7, 2007. The contents of above referenced applications are herein incorporated by reference.

### TECHNICAL FIELD

The present invention relates generally to telemetry systems.

### BACKGROUND OF THE INVENTION

Many industries utilize remote devices to monitor, measure, or record critical data. For example, electricity, water, and natural gas companies use meters located at the customer site to measure utility consumption. Presently, remote telemetry systems are replacing the traditional utility metering systems, which suffer from several inefficacies. For example, a company needs to hire a person to periodically visit each meter in a service area to visually read the consumption as reported by the meter. This may require sending the person into a dangerous area. It also takes a long time for a person to physically visit each meter. Additionally, most electromechanical meters may be opened and tampered with by a person wishing to reduce the utility bill. Since the meter is typically read only about once a month, the tampering may not be evident to the company. Another drawback to the conventional metering system is that local fault detection, such as the detection of a localized blackout or brownout condition, is not possible because the remote device is not measured or accessed on a regular basis.

A telemetry system is capable of monitoring, collecting, analyzing, and displaying data that is remotely generated by a plurality of metering devices. FIG. 1 shows a telemetry system 100 that includes a central data collection (CDC) server 110 coupled to a database 120 and a number N of remote data gathering units 130. The data gathering units 130 may be metering units (e.g., an electricity meter, a gas meter, a water meter, etc.), sensors (e.g., a temperature sensor, a liquid sensor, etc.), or any combination thereof. The gathering units 130 are typically installed within the locality of a subscriber's premises. The gathering units 130 and the CDC server 110 communicate through a cellular network 140, which may be a global system for mobile communication (GSM) network, a code-division multiple access (CDMA) network, and the likes. The CDC server 110 further communicates with a legacy server 150 through a wide area network (WAN) 160. The legacy server 150 is installed at the utility company (e.g., the electricity company) and executes applications related to billing, auditing, and the like.

Each of the data gathering units 130 read the status of its respective utility meters or sensors, and predictably (e.g., one hour) transmit the collected data to the CDC server 110. The CDC server 110 processes the data received from all units 130 to generate reports notification and alarms based on the gathered data (e.g., statistics of the consumption per customers, groups of customers, etc.). The reports are forwarded for the legacy server 150, for example, to bill the customers according to utility usage over a predetermined period of time. The CDC server 110 controls the gathering units 130 via the cellular network 140 by means of a proprietary communications protocol.

In order to ensure reliable operation the primary tasks of the system should be preformed without any failures. In the related art solutions for ensuring the proper operation of sensors and meters can be found, for example, in U.S. Pat. No. 6,731,223 by Partyka, incorporated herein for the useful understanding of the background of the invention. However, there is not an existing technique for enabling failover of the gathering unit 130 if, for example, it fails to transmit data to CDC server 110.

It would be therefore advantageous for to provide a solution in a telemetry system that ensures constant and uninterrupted connection between the data gathering unit and the CDC server.

### BRIEF DESCRIPTION OF THE DRAWINGS

FIG. 1 is a diagram of a telemetry system (prior art)

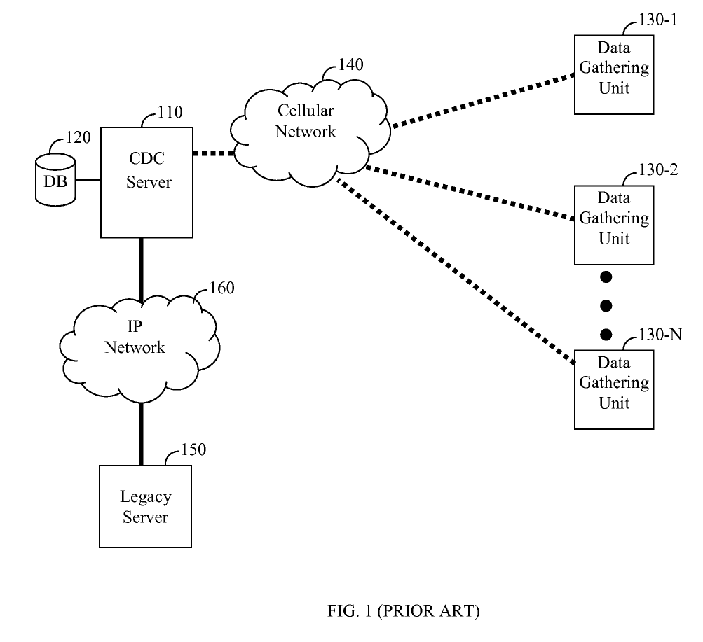

FIG. 2 is a block diagram of a data gathering unit used to describe the objectives of the present invention

FIG. 3 is a flowchart describing the failover process as performed by the CDC server in accordance with an embodiment of the present invention

FIG. 4 is a flowchart describing the failover process as performed by the data gathering unit in accordance with an embodiment of the present invention

### DETAILED DESCRIPTION OF THE INVENTION

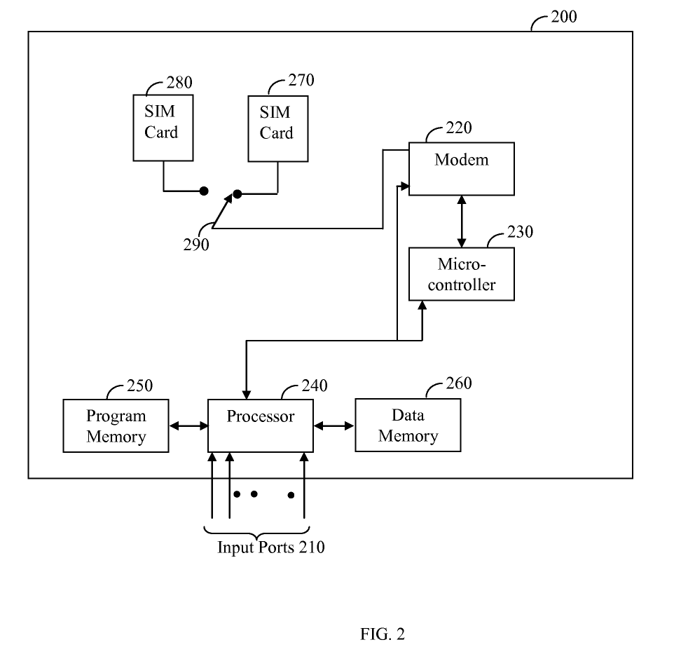

FIG. 2 shows a non-limiting and exemplary block diagram of a data gathering unit 200 used to describe the objectives of the present invention. The data gathering unit 200 includes a plurality of input ports 210 to receive signals from input metering devices and/or sensors, a modem 220, a microcontroller 230 coupled to the modem 220, a processor 240, a program memory 250, a data memory 260, a first subscriber identity module (SIM) card 270 and a second SIM card 280 commonly coupled to a switch 290.

The modem 220 comprises a cellular modem, which communicates through public cellular networks and it is used for communicating with a control station of a cellular network operator to transfer data to the CDC server. The communication link between the modem 220 and the control station optionally includes a two-way communication link. The modem 220 is used to convey raw data and/or partially processed data to the control station typically by means of a general packet radio services (GPRS) protocol. The modem 220 further receives information from a control station sent from the CDC server. For example, the information may include signals for controlling and managing the operation of the data gathering unit 200. Typically, a control station includes an access point name (APN) server that allows connecting the internet via a cellular network. A control station may include one or more APN servers of the same network operator. Each APN server is designated by a different IP address. The modem 220 implements a TCP/IP stack to ensure reliable data transfers over the GPRS protocol. In other embodiments of the disclosed invention the modem 220 may use other types of communications, such as a dedicated cellular network, WiFi, WiMax, satellite communications, short wave communications, and the likes. The microcontroller 230 controls the operation of the modem 220 as well as the SIM cards 270 and 280.

The processor 240 analyzes the data received through the input ports 210, modem 220 and SIM cards 270 and 280. Data received from the modem 220 and SIM cards may include control information sent from the CDC server. The processor 240, as result of processing the control information, generates control signals that are provided to other elements of the data gathering unit 200 for the purpose of operation of the gathering unit and the metering device as well as performing the failover process. The content of the control information and the control signals as well as the failover process are described in greater detail below. The program memory 250 is a Flash and a RAM used for at least storing software run by the processor 240.

A data memory 260 is a Flash memory (or any other type of non-volatile memory) used to store accumulated data until it is transmitted to the CDC server. Raw data in the memory 260 may be transmitted continuously, for example, every few seconds or minutes, periodically, for example, once a day or week, or when a predetermined amount of data is collected. Additionally, data is transmitted to the control station, upon a request from the CDC server for desired data. Alternatively, data is transmitted at times determined according to the availability of cellular bandwidth and/or when low cellular rates are available.

The SIM cards 270 and 280 store the key identifying a cellular telephone service subscriber, saved telephone numbers, preferences, and other information. Each SIM is uniquely identified by its international circuit card ID (ICCID). In accordance with the present invention only one SIM card is active, where the active card is switched to the modem 220 through the switch 290. Each of the SIM cards may be configured to operate with a different network operator. This allows alternating between network operators, for example, if the connection with the control station of one of the operator is failed. In accordance with other embodiment only a single SIM card is installed in the gathering unit 200. In this embodiment, the SIM card may be remotely configured or programmed by the CDC server to switch to another cellular network operator. In accordance with another embodiment of the present invention the micro-controller 230 is pre-configured with data of a plurality of different SIM cards, each of which has its own identification number and each is associated with different network operator. According to this embodiment the micro-controller 230 can program the inactive SIM card (e.g., either card 270 or 280) with data of one the SIM cards data stored therein. Thereafter the inactive SIM card is switched to be the active card. The programming of the SIM cards by the micro-controller 230 is performed during the operation of the data gathering unit 200 and does not require re-booting of the unit.

In accordance with the present invention the telephone numbers of which the CDC server called from is associated with failover actions. In order to trigger one of these actions, the CDC server dials from the number associate with the desired action. The active SIM card identifies the dialed caller's number and provides the processor 240 with an indication of the action to be executed.

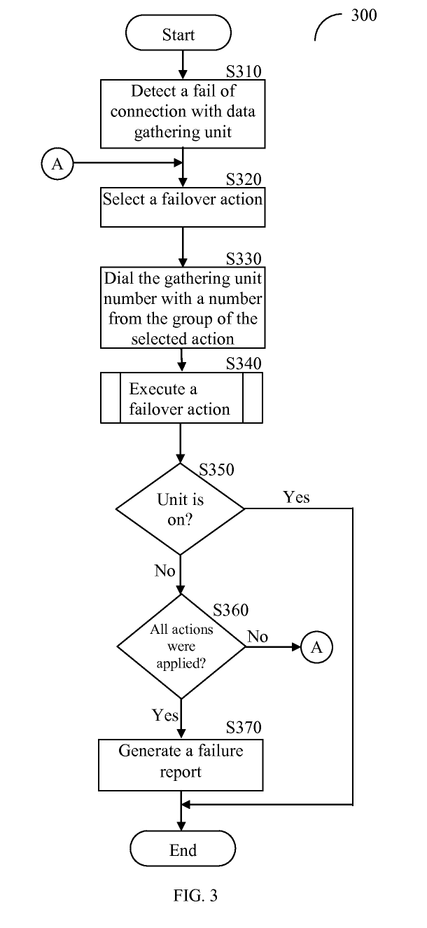

FIG. 3 shows a non-limiting and exemplary flowchart 300 describing the failover process in accordance with an embodiment of the present invention. The failover process ensures uninterrupted connection between the gathering units and a CDC server, thereby ensuring the proper operation of telemetry systems. As mentioned above, several failover actions can be applied to restart the communication between the data gathering unit and the CDC server. As a non-limiting example, eight groups A through G are defined for eight different failover actions. Specifically, Group-A includes telephone numbers instructing the gathering unit to send data stored in the memory 260; Group-B includes telephone numbers instructing the gathering unit to connect to a different control station (APN) of the same network operator; Group-C has includes telephone numbers instructing the gathering unit to switch between SIM cards by means of a switch 290; Group-D comprises telephone numbers for instructing the gathering unit 200 to perform a “cold” reset; Group-E includes telephone numbers for performing a “warm” reset; Group-F includes telephone numbers for roaming to another network operator; and Group-F instruct the gathering unit to be prepare and act for software upgrade remote download. It will be apparent to a person skilled in the art that other type of failover actions can be defined and the actions described herein are merely examples.

The failover process stars at S310, when the CDC server detects that the gathering unit does not respond. The detection may be achieved by using a watchdog mechanism alerting that no data has been sent from the gathering unit 200 during a predefined time interval or when data was supposed to be sent. Alternatively, gathering unit is considered as unresponsive if it does not respond to keep-alive messages sent from the CDC server. At S320 an attempt is made to reestablish the connection with the data gathering unit by selecting a single failover action from a list of predefined actions. The order and type of actions in the list is configurable. At S330 the CDC server dials from a telephone number, for example, implemented by modem from the group associated with the selected action. If the data gathering unit 200 does not answer the call, a different number (modem) from the group is dialing. At S340 the data gathering unit accepts the call and tries to execute the failover action requested by the CDC server.

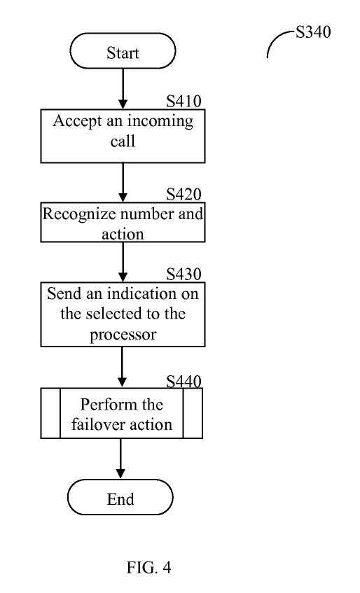

Referring to FIG. 4 the execution of S340 is described in greater detail. At S410 an incoming call is received. At S420 the dialing number and the failover action associated with the number are recognized by the active SIM card and the gathering unit. At S430 an indication of the failover action to be preformed is sent to the processor 240, which on its turn, at S440 executes the requested failover. Specifically, if the failover action is sending data to the CDC eight, the processor 240 retrieves un-transmitted information from the data memory 260, processes the information, and forwards it to the modem 220. The modem 220 transmits the data to the CDC server as described in detail above. If the failover action is of Group-B the modem 220 sends the data to a different APN server using a different address. For a failover action from Group-C, the processor 240 controls the switch 290 to connect the inactive SIM cards, thereby enabling transferring data using a different network operator. A recognized number from Group-D would reset, for example, the microcontroller 230 and the software execute by the processor 240. If the action is of Group-E the gathering unit 200 is reset. For a failover action from Group-F, the processor 240 instructs the active SIM cards to roam to another network operator; and in case of numbers from Group-F the gathering unit acts for software upgrade from the CDC server by remote download.

Referring back to FIG. 3, at S350 an attempt is made, by the CDC server, to communicate with the gathering unit, and if it succeeds execution terminates; otherwise, execution continues with S360 where it is checked whether all the predefined failover actions have been applied. If so, at S370, a failure report is generated and sent to a user; otherwise, execution returns to S320. The report may include the ID number of the gathering unit, time of failure, and the actions that were performed. The report may be sent as an email message, a SMS message, and so on.

In accordance with another embodiment of the present invention the gathering unit 200 can automatically detect a failure (e.g., data cannot be transmitted or received) and to execute one or more of the failover actions describe above in order to overcome the detect failure.

The present invention has now been described with reference to a specific embodiment where the failover protocol is implemented by dialing from predefined numbers. Other embodiments will be apparent to those of ordinary skill in the art. For example, the failover protocol may comprise sending SMS messages or other type of messages that would include the failover action. It should be noted that the methods disclosed hereinabove may be implemented in hardware, software, firmware or any combinations thereof.

1. A method for performing failover in telemetry systems to allow continuous and uninterrupted connection between data gathering units and a central data collection (CDC) server, comprising:
detecting an unresponsive data gathering unit;
selecting a failover action from a list of predefined failover actions; and
sending a signal from the CDC server to the gathering unit, wherein the signal carries the failover action to be taken.

2. The method of claim 1, further comprising:
executing the failover action by the data gathering unit.

3. The method of claim 2, further comprising:
determining if the data gathering unit turns responsive after the execution of the failover action; and
performing another failover action from the list of predefined failover actions if the data gathering unit is still unresponsive.

4. The method of claim 3, further comprising:
generating an error message if the data gathering unit remains unresponsive after applying all failover actions in the list of predefined office actions.

5. The method of claim 2, wherein the failover action comprises at least one of:
sending data stored in the data gathering unit to the CDC server;
connecting to a different control station (APN);
switching between SIM cards of the data gathering unit;
performing a cold reset; performing a warm reset;
roaming to another network operator; and
remotely downloading software software.

6. The method of claim 5, wherein the signal that carries the failover action comprises at least a predefined dialing number associated with the failover action.

7. The method of claim 6, wherein executing the failover action further comprising:
identifying the dialing number associated with the failover action; and
performing instructions associated with the failover over.

8. A data gathering unit adapted to automatically perform failover actions to allow continuous and uninterrupted connection with a central data collection (CDC) server, comprising:
a modem for communicating with the CDC server over a network;
a processor for performing the failover actions;
a program memory for storing instructions associated with the failover actions; and
a plurality of subscriber identity module (SIM) cards coupled to a switch.

9. The data gathering unit of claim 1, further comprising:
a data memory for storing raw data collected by the data gathering unit.

10. The data gathering unit of claim 8, wherein the modem is at least a cellular modem and wherein the network is at least a cellular network.

11. The data gathering unit of claim 10, wherein the failover action comprises at least one of:
sending data stored in the data memory to the CDC server;
connecting to a different control station (APN) of the network;
switching between the plurality of SIM cards;
performing a cold reset; performing a warm reset;
roaming to another network operator; and
remotely downloading upgrade software.

12. The data gathering unit of claim 11, wherein the processor is further being capable of:
receiving a signal for executing a failover action; and
executing the instructions stored in the program memory and associated with the failover action.

13. The data gathering unit of claim 12, wherein the signal comprises at least a predefined dialing number associated with the failover action.

14. A telemetry system adapted to automatically performing failover actions to allow continuous and uninterrupted connection between a plurality of data gathering units and a central data collection (CDC) server, comprising:
a CDC server for detecting unresponsive data gathering units;
a plurality of data gathering units, wherein each data gathering unit is capable of performing failover actions; and
a network for connecting the CDC servers and the plurality of data gathering units.

15. The telemetry system of claim 14, wherein the CDC server processes raw data collected by the data gathering units.

16. The telemetry system of claim 14, wherein the CDC server is further being capable of:
selecting a failover action from a list of predefined failover actions; and
sending a signal to the unresponsive data gathering units, wherein the signal carries the failover action to be taken;
determining if a data gathering unit turns responsive after the execution of the failover action;
performing another failover action from the list of predefined failover actions if the data gathering unit is still unresponsive; and
generating an error message if the data gathering unit remains unresponsive after all the failover actions were applied.

17. The telemetry system of claim 16, wherein the signal comprises a predefined dialing number.

18. The telemetry system of claim 16, wherein the data gathering unit comprises:
a modem for communicating with the CDC server over a network;
a processor for performing the failover actions;
a program memory for storing instructions associated with the failover actions; and
a plurality of subscriber identity module (SIM) cards coupled to a switch.

19. The telemetry system of claim 18, wherein the failover action comprises at least one of:
sending data stored in the data memory to the CDC server;
connecting to a different control station (APN) of the network;
switching between the plurality of SIM cards;
performing a cold reset;
performing a warm reset;
roaming to another network operator; and
remotely downloading upgrade software.

20. A computer readable medium having stored thereon one or more machine executable instructions that, when executed by a machine, implement a method for synchronizing between a computing device and a wireless docking station, wherein the method enables a wireless connection between the computing device and the wireless docking station, the method comprising:
a modem for communicating with the CDC server over a network;
a processor for performing the failover actions;
a program memory for storing instructions associated with the failover actions; and
a plurality of subscriber identity module (SIM) cards coupled to a switch.
